(19) United States
(12) Patent Application Publication
(10) Pub. No.: US 2026/0187208 A1
(43) Pub. Date: Jul. 2, 2026

(54) PERSONAL JOURNEY BASED SECURE AUTHENTICATION

(71) Applicant: International Business Machines Corporation, Armonk, NY (US)

(72) Inventors: Loucas Loumakos, Austin, TX (US); Adithi Thumballi Ganapathi, Austin, TX (US); Meenakshi Kumari, Austin, TX (US); Ravithej Chikkala, Pflugerville, TX (US); Justin Bonyoma, Austin, TX (US)

(73) Assignee: International Business Machines Corporation, Armonk, NY (US)

(21) Appl. No.: 19/007,951

(22) Filed: Jan. 2, 2025

(51) Int. Cl. G06F 21/31

(52) U.S. Cl. CPC G06F 21/31

(57) ABSTRACT

An embodiment initiates a first data collection process to collect event data corresponding to a user interacting within a space. The embodiment generates a personal journey comprising a sequence of events based on the one or more events extracted from the event data collected. The embodiment initiates, upon detection of a trigger condition, a second data collection process to collect additional event data corresponding to the user interacting within the space. The embodiment generates a predicted sequence of events. The embodiment generates an actual sequence of events. The embodiment generates, by computationally comparing the actual sequence of events to the predicted sequence of events, a similarity metric between the actual sequence of events and the predicted sequence of events. The embodiment initiates a first responsive action upon determination that the similarity metric does not meet a predefined similarity metric threshold.

### BACKGROUND

The present invention relates generally to secure authentication. More particularly, the present invention relates to a method, system, and computer program for personal journey-based secure authentication.

Artificial intelligence (AI) technology has evolved significantly over the past few years. Modern AI systems are achieving human level performance on cognitive tasks like converting speech to text, recognizing objects and images, or translating between different languages. This evolution holds promise for new and improved applications in many industries.

An Artificial Neural Network (ANN)—also referred to simply as a neural network—is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex but on much smaller scales. A large ANN might have hundreds or thousands of processor units, whereas a mammalian brain has billions of neurons with a corresponding increase in magnitude of their overall interaction and emergent behavior.

Two-Factor Authentication (2FA) is a security process that requires a user to provide two different forms of identification to verify a user's identity when accessing a system, area, location, application, and/or user account. For example, when a user attempts to log in to an account, the user may be required to enter their login credentials (e.g., username and password) which serves as a first layer of security (or “factor” of authentication), as well as may be prompted for a second factor of authentication, such as a one-time code transmitted to the user's smartphone. The additional factor of authentication ensures that even if a non-authorized user accessed the user's login credentials, the unauthorized user may still be prevented from logging into the user's account, given that the unauthorized user does not have access to the user's one-time code transmitted to the user's smartphone. Many types and combinations of 2FA are known and used in various industries, applications, and settings, to enhance secure access by only authorized users.

### SUMMARY

The illustrative embodiments provide for personalized journey based secure authentication.

An embodiment includes initiating a first data collection process to collect event data corresponding to a user interacting within a space. The embodiment also includes extracting one or more events from the event data collected. The embodiment also includes generating a personal journey based on the one or more events extracted from the event data collected, wherein the personal journey comprises a first sequence of events. The embodiment also includes initiating, upon detection of a trigger condition, a second data collection process to collect additional event data corresponding to the user interacting within the space. The embodiment also includes generating a predicted sequence of events based on a portion of the additional event data and the first sequence of events. The embodiment also includes generating an actual sequence of events based on the additional event data. The embodiment also includes generating, by computationally comparing the actual sequence of events to the predicted sequence of events, a similarity metric between the actual sequence of events and the predicted sequence of events. The embodiment also includes initiating a first responsive action upon determination that the similarity metric does not meet a predefined similarity metric threshold.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example network infrastructure in accordance with an illustrative embodiment;

FIG. 3 depicts a block diagram of an example personal journey authenticator module in accordance with an illustrative embodiment;

FIG. 4 depicts a block diagram of an example system for providing personal journey based authentication in accordance with an illustrative embodiment;

FIG. 5 depicts a flowchart of an example process for personal journey prediction and evaluation in accordance with an illustrative embodiment;

FIG. 6 depicts a flowchart of an example process for personal journey based authentication evaluation in accordance with an illustrative embodiment;

FIG. 7 depicts a flowchart of an example process for personal journey event categorization in accordance with an illustrative embodiment; and

FIG. 8 depicts a flowchart of an example process for personal journey based secured authentication in accordance with an illustrative embodiment.

### DETAILED DESCRIPTION

Security is a constantly evolving landscape that requires constant innovation to combat emerging challenges, threats, and system and organization vulnerabilities. Two-factor authentication (“2FA”) has long existed and is used as an additional layer of security in many security solutions that exist today. There are various advantages and disadvantages associated with different respective 2FA security solutions, though they all share a similar unsolved deficiency: inconvenience. Accordingly, the perceived inconvenience of 2FA security solutions existing today causes many users to choose not to adopt 2FA, or alternatively, use 2FA incorrectly. If users do not properly utilize existing 2FA methods, then systems and organizations remain vulnerable to comprise.

Further, 2FA often require certain technical components that are often susceptible and vulnerable to attack or otherwise may malfunction. Even further, cybercriminals continue to find ways to exploit vulnerabilities in 2FA systems, highlighting the importance of ongoing efforts to improve cybersecurity measures. For example, many existing 2FA methods require the use of hardware tokens, SMS messages, or email notifications as the second factor of authentication. These components can be vulnerable to interception or spoofing, allowing cybercriminals to bypass the authentication process. Moreover, the technical components used in traditional 2FA methods may suffer from vulnerabilities that can be exploited by cybercriminals. For instance, hardware tokens can be lost or stolen, compromising the security of the authentication process. Similarly, SMS messages can be intercepted through SIM swapping attacks, while email notifications may be vulnerable to phishing attacks that trick users into revealing their credentials.

Cybercriminals are constantly evolving their tactics to exploit vulnerabilities in 2FA systems, underscoring the need for ongoing efforts to enhance cybersecurity measures. As new attack vectors emerge and existing vulnerabilities are discovered, traditional 2FA methods may struggle to keep pace with the evolving threat landscape. This highlights the importance of implementing robust security protocols and continuously updating 2FA systems to mitigate the risks posed by cyber threats.

In today's digital age, there are smart devices and IoT devices within almost every system or organization and smart devices utilized by almost every member of an organization. Perhaps one of the most widely utilized smart devices in possession of nearly all users is the smartphone. Accordingly, the smartphone is a type of smart device with various sensors, including but not limited to, GPS sensors, accelerometers, inertial measurement units (IMUs), gyroscopes, and the like. Further, various other smart devices and sensors are widely available. For example, a smart watch may be able to collect data on a user's body temperature, perspiration, heart rate, and more. Further, a pair of smart glasses may be able to detect and collect data on the movement of a user's eye movements, iris pattern, blink frequency, blink speed, pupil dilation, and more.

In addition to wearable smart devices, various sensors exist throughout most of the buildings that people inhabit every day. These types of sensors may include, but are not limited to, cameras, elevator sensors, security access doors, and more. For example, an elevator may include a weight sensor, that may be configured to detect the weight of one or more users within the elevator, as well as various buttons to cause the elevator to ascend/descend to particular floors, which may be recorded in a computer memory.

Further, it is contemplated herein the present disclosure that every individual user may correspond to a unique combination of sensor data collected about that user as the user interacts within their environment in a typical matter. For example, an individual user may have a particular combination of body temperature fluctuations, heart rate, eye movements, body mass, walking speed, stride length, and the like. It is further contemplated that the greater number of variables of combined variables, the greater likelihood that the combination of those variables is a unique combination of variables.

Systems and organizations already possess many sensors and sensor systems that may be leveraged to collect unique data corresponding to users interacting with those systems and/or within those organizations. For example, a security camera may track a user's movements, an elevator may track a user's weight, a smartphone connected to Wi-Fi may enable Wi-Fi mapping to track a user's movement speed, and so forth. Further, smartphones, with their array of built-in sensors, have become a cost-effective and modern spatial data source for indoor mapping through crowdsourcing, and other IoT devices may enable Wi-Fi location tracking for assets and other objects indoors.

Embodiments of the present disclosure define a method of creating personalized journeys and using said personal journeys as a novel approach for multi-factor secure authentication. In some embodiments, the personalized journey based secure authentication systems and methods disclosed herein may require no additional action for a user to initiate. An embodiment of the present disclosure includes creating a creating a personal journey (“PJ”) for a person (such as an employee) in a professional setting (such as a building) with an existing access fabric. An embodiment of the present disclosure also includes leveraging a PJ to accomplish more secure multi-factor authentication. In some embodiments, the PJ-based authentication may be used in place of currently existing 2FA authentication. In some other embodiments, the PJ-based authentication may be used in addition to currently existing (or to be developed) 2FA authentication.

To address the limitations of currently existing 2FA technology, embodiments of the present disclosure consider combining data resultant from various sensors and/or or sensor systems to generate personal journeys as a part of a multi-factor authentication system and process. By integrating these data sources and leveraging machine learning models, systems and organizations can develop more secure authorized access authentication procedures, policies, and protocols.

The present disclosure addresses the deficiencies described above by providing a process (as well as a system, method, machine-readable medium, etc.) that develops personal journey based secure authentication that leverages various sensors and an event platform together with one or more machine learning models to generate personal journeys and evaluate potential authorized users against those personal journeys. A “personal journey” (or simply “PJ”) as referred to herein refers to any defined collection of events of a person moving though and/or interacting within a monitored space as that person enters the space for the first time or as that person departs from a secure access point device that will later require authentication to access.

As used throughout the present disclosure, the term “event” refers to a data point associated with a monitored instance of an activity. Further, in the context of the Personal Journey 2-Factor Authentication (PJ2FA) method, an event represents a specific action, interaction, or occurrence that is captured and recorded as part of a user's journey through a monitored physical space. These events serve as individual data points that contribute to the overall personal journey of the user and are used to track and analyze the user's movements and behaviors within the environment. Each event provides may provide information about the user's activities and interactions, which may be utilized for generating and updating the user's personal journey for authentication purposes.

As used throughout the present disclosure, the term “event fabric” refers to a comprehensive collection and/or integration of all events generated by a user's interactions within a monitored physical space. The event fabric encompasses the entirety of data points associated with the user's personal journey, including various types of events such as physical movements, access events, and other interactions captured by sensors and devices within the environment. By consolidating and organizing all events into a cohesive fabric, the system can analyze and interpret the user's activities, patterns, and behaviors within the monitored space. This holistic view of the user's journey enables the system to make accurate predictions, evaluations, and authentication decisions based on the user's dynamic interactions and movements.

In some embodiments, the event fabric includes event fabric may include a platform that serves as the underlying infrastructure for collecting, processing, and managing the diverse events generated by a user's interactions within a monitored physical space. The platform within the event fabric plays a crucial role in orchestrating the flow of events, integrating data from various sources, and facilitating the analysis and utilization of this information for authentication purposes. The platform within the event fabric acts as a centralized system that aggregates events from different sensors, devices, and data sources within the monitored environment. By incorporating a platform into the event fabric, the system can efficiently handle large volumes of event data and support real-time updates to the user's personal journey. Moreover, the platform within the event fabric may offer capabilities for data processing, event correlation, and pattern recognition to derive meaningful insights from the collected events.

As used throughout the present disclosure, the term “secure access point” refers to any point in physical and/or virtual space where access may be limited to an authorized user having sufficient privileges to access said secure access point. A non-exhaustive list of some example secure access points may include, but is not limited to, Online Banking Platforms, Cloud Storage Services, Corporate Email Systems, Project Management Tools, Virtual Private Networks (VPNs) Developer Repositories, Electronic Health Record (EHR) Systems, Secured Office Areas, Data Centers, Research Labs, Military Facilities, Airports, Warehouses, Parking Garages, Smart Home Systems, Building Management Systems, IoT Device Platforms, and and/or any combination thereof, and the like.

Embodiments disclosed herein describe the entity designated for security monitoring as a physical space such as an office building. However, use of this example is not intended to be limiting, but is instead used for descriptive purposes only. Instead, the entity designated for security monitoring can include elements of or more of a network environment, an organization, a physical location, a software application, as well as a component of a system, as well as any sub-component of any component, as well as any combination thereof.

Further, although in some embodiments a physical building is described, use of this example is not intended to be limiting, but is instead used for descriptive purposes only. Instead, the monitored environment may include, but is not limited to, a computer system, a digital platform, a digital environment, a virtual reality (“VR”) platform, an augmented reality (“AR”) platform, a mixed-reality platform, as well as any other environment (physical, virtual, and/or any combination thereof) that may be monitored using a sensor, and/or any other environment from which user interaction data may be obtained.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

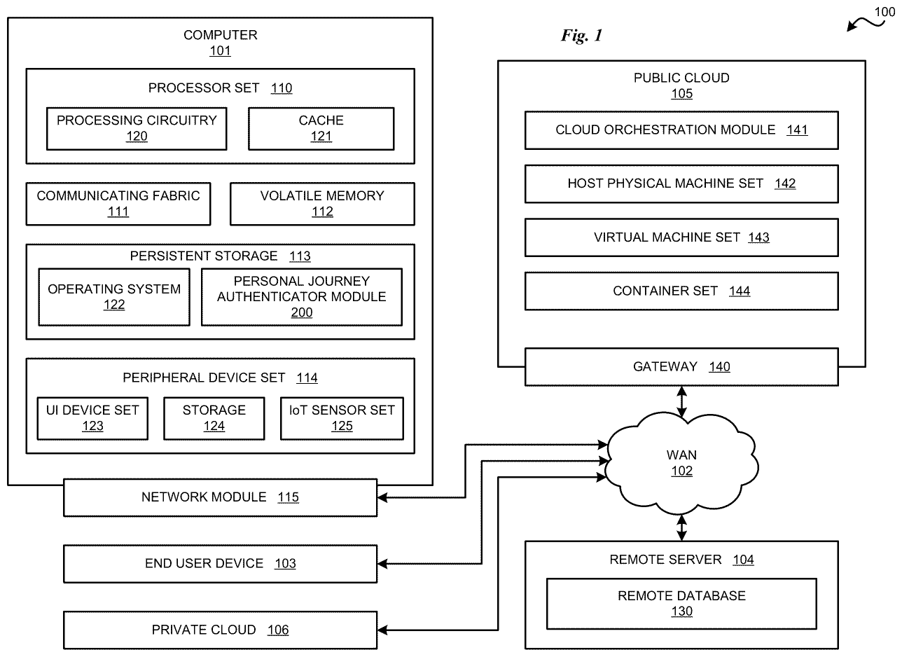

FIG. 1 depicts a block diagram of a computing environment 100. Computing environment 100 contains an example of an environment for the execution of at least some of the computer code involved in performing the inventive methods, such as personalized journey authenticator module 200 that provides for personalized journey based secure authentication, including personal journey creation and personal journey evaluation. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

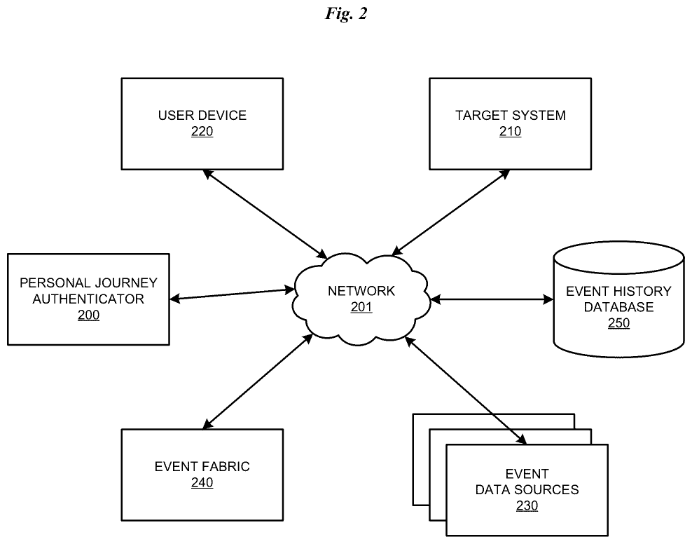

FIG. 2 depicts a block diagram of an example network infrastructure in accordance with an illustrative embodiment. In the illustrated embodiment, the personal journey authenticator module 200 includes personal journey authenticator module 200 of FIG. 1.

In the illustrated embodiment, personal journey authenticator module 200 is configured to perform various operations, as described in greater detail herein. In an embodiment, the personal journey authenticator module 200 is configured to establish a connection to target system 210 via any suitable network 201 to perform the following example operations. In an embodiment, upon establishing a connection with target system 210, the personal journey authenticator module 200 begins monitoring user interactions across the target system 210. In an embodiment, personal journey authenticator module 200 monitors interactions across target system 210 by collecting event data captured by user device 220 belonging to a user interacting within target system 210. In an embodiment, personal journey authenticator module 200 extracts one or more events that occur during interaction within target system 210. In an embodiment, execution of an event monitoring program yields one or more events, and combination of events collectively defines a personal journey.

In the illustrated embodiment, the personal journey authenticator module may be configured to initiate a first data collection process to collect event data corresponding to a user interacting within a space, extract one or more events from the event data collected, and generate a personal journey based on the one or more events extracted from the event data collected, such that the personal journey comprises a first sequence of events. Further, personal journey authenticator module 200 may be configured to initiate, upon detection of a first trigger condition, a second data collection process to collect additional event data corresponding to the user interacting within the space and generate a predicted sequence of events based on a portion of the additional event data and the first sequence of events. Further, the personal journey authenticator module 200 may be configured to generate an actual sequence of events based on the additional event data, generate, by computationally comparing the actual sequence of events to the predicted sequence of events, a similarity metric between the actual sequence of events and the predicted sequence of events, and initiate a first responsive action upon determination that the similarity metric does not meet a predefined similarity metric threshold.

In an embodiment, the first data collection process comprises collecting body movement data corresponding to the user. In an embodiment, the first data collection process comprises collecting movement speed data corresponding to the user. In an embodiment, the first responsive action includes initiating a request for additional authentication information. In an embodiment, the first responsive action includes denying access to a secure access point. In an embodiment the first trigger condition comprises moving a predefined distance away from a secure access point.

In the illustrated embodiment, the personal journey authenticator module 200 includes a process mining component configured to extract and/or analyze events that occur during an interaction session across target system 210. In an embodiment, the process mining component of personal journey authenticator module 200 collects and analyzes event data generated during interactions with the target system 210.

In the illustrated embodiment, the personal journey authenticator module 200 includes an event prediction component. In an embodiment, the event prediction component employs one or more algorithms and/or trained machine learning models predict an event based on historical event data stored on event history database Accordingly, by leveraging a trained machine learning model, personal journey authenticator module 200 can interpret the relationships between different events, develop insight regarding past actions taken across the target system 210, identify users based on event history and/or personal journey history, and/or predict future actions of a user interacting with target system 210 to evaluate and/or validate the identity of a user attempting to access and access point of target system 210.

In an embodiment, events may be collected from various event data sources 230 as well as user device 220. In some embodiments, event data sources 230 include various sensors and/or sensor systems. For example, event data sources 230 may include, but are not limited to, cameras, smartphones, wearable devices, IoT devices, and the like. Further, in the illustrated embodiment, event fabric 240 provides a platform for aggregating and/or analyzing events.

As a nonlimiting example, suppose target system 210 includes an office building with workstation computer within the office building. In such a scenario, personal journey authenticator 200 may be configured to create a personal journey for a user, such as an employee of an organization, who routinely enters the office building to access the workstation computer. In such a scenario, event data captured by the user device 220 of the user, and/or event data captured by various sensors and/or sensor systems of other event data sources 230 may be used to create a personal journey for the user. In further accordance with the example scenario depicted, various scenarios may exist that may amount to a personal journey for a user interacting within the office building. For example, in one scenario, a personal journey may include a person walking from their desk to a kitchen to heat their food for lunch. In another example scenario, a personal journey may include a person walking from the kitchen to a meeting room to attend a meeting. In yet another example scenario, a personal journey may include a person walking from their workstation to the facilities. In yet another example scenario, a personal journey may include a person walking from a meeting room to a colleague's workstation.

In each of the example scenarios depicted above, a personal journey may be created for a user based on events captured by various sensors and/or sensor systems while monitoring the user walking to and from different locations. Further, in each of the example scenarios depicted, each personal journey created may be used as a means and/or factor for authenticating the identity of a user attempting to access a particular access point of target system 210.

To further illustrate the concept of a personal journey, consider the following non-limiting example. A personal journey may include a user entering an office building, taking the elevator to a particular floor, and walking a particular distance to their workstation. Upon approaching a secure access point, such as a computer workstation, the personal journey authenticator module 200 evaluates whether the approaching user is the authorized user of that workstation based on a comparison of the personal journey of the actual authorized user corresponding to that access point, and the personal journey of the person who just walked up to the workstation. Further, sensor inputs may be used to capture access events as a person moves through an area with access devices such as cameras, card readers, elevators or motion sensors, as described in greater detail in some example embodiments disclosed herein.

In an embodiment, the personal journey authenticator module 200 utilizes cameras as sensors to capture visual data of the user as they move through the environment. These cameras and/or the personal journey authenticator module 200 may utilize image processing algorithms to identify the user based on facial recognition technology. By analyzing the visual data captured by the cameras, the system can track the user's movements and verify their identity based on their unique facial features.

In an embodiment, the personal journey authenticator module 200 utilizes smartphone sensors such as for example, accelerometers, gyroscopes, and magnetometers to collect movement data. These sensors can detect the user's walking patterns, speed, and direction of movement. By analyzing the movement data collected from the smartphone sensors, the system can create a unique gait pattern profile for the user, which can be used as an authentication factor.

In an embodiment, the personal journey authenticator module 200 utilizes RFID sensors that may be placed at various checkpoints along the personal journey route. In an embodiment, these RFID sensors may be configured to detect RFID tags embedded in the user's belongings, such as ID badges or access cards. By tracking the user's progress through the environment based on the RFID tag detections, the system can ensure that the user is following their designated personal journey path.

In an embodiment, the personal journey authenticator module 200 utilizes Bluetooth beacons as sensors strategically placed throughout the environment. These Bluetooth beacons communicate with the user's smartphone to determine their proximity and location within the building. By measuring the signal strength and triangulating the user's position based on multiple Bluetooth beacons, the system can accurately track the user's movements in real-time.

In an embodiment, the personal journey authenticator module 200 may utilize one or more biometric sensors such as fingerprint scanners, iris scanners, etc., to collect biometric data for authentication purposes. These sensors can capture unique biometric identifiers of the user, such as fingerprints or iris patterns, to ensure secure authentication during the personal journey. By comparing the biometric data collected from the sensors with the user's pre-enrolled biometric templates, the system can verify the user's identity with a high level of accuracy.

In an embodiment, the personal journey authenticator module utilizes one or more environmental sensors such as temperature sensors, humidity sensors, and light sensors to provide contextual data about the user's surroundings. These sensors can detect environmental conditions in the user's vicinity during their personal journey. By analyzing the environmental data collected from these sensors, the system can further authenticate the user based on their typical environment preferences and behavior patterns.

In an embodiment, the personal journey authenticator module 200 includes a WiFi component that leverages WiFi signals and optionally the gyroscope/accelerometer sensors of a person's smart device to triangulate the position and optionally track the number of steps taken during their personal journey. The WiFi component utilizes the WiFi signals emitted by access points within the environment to determine the user's location based on signal strength and proximity. By combining this WiFi-based positioning with data from the gyroscope/accelerometer sensors on the user's smart device, the system can triangulate the user's position more accurately and calculate the number of steps taken by the user as they move through the environment.

In an embodiment, the personal journey authenticator module 200 utilizes an Asynchronous WiFi crowdsourced map 450 to further enhance the accuracy of tracking personal journey events. This crowdsourced map contains information about the WiFi signal strength and locations of access points collected from multiple users over time. By referencing this map, the system can improve the positioning accuracy by cross-referencing the user's current WiFi signal strength with the data stored in the crowdsourced map. This collaborative approach to WiFi-based positioning helps in refining the user's location estimation and provides a more reliable tracking mechanism for personal journey authentication.

In an embodiment, the personal journey authenticator module 200 may leverage a user's personal and/or professional calendar to enhance the authentication process. By integrating the user's calendar data, the system gains the ability to correlate scheduled events with the user's physical location and movements during their personal journey. This integration offers several functionalities. In some cases, the system can match the user's scheduled meetings with the locations they are expected to be in, thereby cross-referencing meeting room details from the calendar with the user's actual presence in those rooms to verify adherence to the planned personal journey. Also, by comparing the scheduled meeting hours in the calendar with the timestamps of the user's movements captured by sensors, the system can align meeting hours with the actual times the user enters and exits meeting rooms or other designated locations to validate their activities during the personal journey. Even further, the system can identify suspicions related to Paid Time Off (PTO) by detecting anomalies in the user's calendar, such as unexpected absences or discrepancies in scheduled activities. For example, if the calendar indicates PTO but sensor data shows movement within the office building, the personal journey authenticator module 200 can raise alerts to verify the user's status and prevent unauthorized access. By combining calendar data with sensor-based tracking, the personal journey authenticator module provides a comprehensive and context-aware authentication mechanism that considers the user's scheduled commitments and activities, enhancing the accuracy and security of the personal journey authentication process.

In an embodiment, the event fabric 240 includes the real-time collection of events that enable a person to navigate a building efficiently. This collection of events includes data from various sources such as keycard readers, elevators, cameras, WiFi signals, and other sensors. By integrating data from these sources, the event fabric creates a comprehensive real-time map of the user's movements within the building. Accordingly, by combining data from keycard readers, elevators, cameras, WiFi signals, and other sensors, the event fabric 240 facilitates real-time tracking and navigation for the user within the building. This integrated approach enhances security, efficiency, and personalized navigation experiences based on the user's interactions with various building elements.

In an embodiment, the personal journey authenticator module 200 may be configured to perform a comprehensive analysis of the target system 210 and user interactions across the target system 210 to understand the underlying dynamics of the system, behavior of a user interacting with the system, and/or sequences of events and taken place over a system, as well as their associated outcomes. Further, by leveraging the one or more deep learning algorithms to process event data extracted during interaction monitoring, the personal journey authenticator module 200 is able to decipher the sequence of events and as well as predict a future expected event based on a current personal journey. In some embodiments, the one or more deep learning algorithms may be utilized to generate insights within the target system 210 and uncover the context, relationships, intentions, and implications of user actions in the environment.

In the illustrated embodiment, personal journey authenticator module 200 is communicatively coupled to event history database 250. In an embodiment, event history database 250 is configured to store all event history data and context data related to actions obtained during monitoring users interacting within target system 210. Accordingly, the event history database 250 is designed to capture a comprehensive record of all interactions and events within the target system 210, thereby providing a comprehensive source of information for analysis and decision-making processes. In an embodiment, the event history database 250 stores detailed information about each action taken within the target system 210, including the type of action, timestamp, user ID, and any associated metadata. This data allows the personal journey authenticator module 200 to track the sequence of events, identify patterns, and detect anomalies that may indicate potential security threats or vulnerabilities.

Further, in an embodiment, data stored on event history database 250 includes event timestamps, categorizing events based on their type such as physical movements, access events, and interactions with sensors. Each event is associated with the user's identifier, linking the data to specific individuals for personalized tracking. Location data is stored to track the user's whereabouts during each event, providing details on the physical space or area where the event occurred. Additionally, sensor data captured by various monitoring devices like WiFi access points and cameras is recorded to offer additional context to the events. The database maintains the sequence of events experienced by the user, enabling the reconstruction of the user's personal journey and analysis of their behavior patterns. Furthermore, authentication events are stored to verify the user's identity based on their historical interactions within the space. By storing this diverse data, the event history database forms a comprehensive record of the user's activities, interactions, and movements, serving as the basis for generating, updating, and utilizing the user's personal journey for secure and reliable two-factor authentication.

In the illustrated embodiment, user device 220 allows a user with sufficient privileges to perform various tasks associated with personal journey authenticator module 200. In some embodiments, user device 220 allows a user with administrative privileges to perform various administrative tasks associated with personal journey authenticator module 300, as described in greater detail herein. User device 220 may include any type of computing device, including but not limited to, a desktop computer, a laptop, a smartphone, a tablet, a wearable device, and/or any combination thereof.

In an embodiment, a service infrastructure provides services and service instances to a user device 220. In an embodiment, user device 220 communicates with the service infrastructure via an API gateway. In various embodiments, the service infrastructure and its personal journey authenticator module 200 serve multiple users and multiple tenants. A tenant is a group of users (e.g., a company) who share a common access with specific privileges to the software instance. In some embodiments, the service infrastructure ensures that tenant specific data is isolated from other tenants. In some embodiments, user device 220 connects with an API gateway via any suitable network or combination of networks such as the Internet, etc. and uses any suitable communication protocols such as Wi-Fi, Bluetooth, etc. Service infrastructure may be built on the basis of cloud computing. In an embodiment, the API gateway provides access to client applications like personal journey authenticator module 200. In some embodiments, the API gateway receives service requests issued by client applications and creates service lookup requests based on service requests. As a non-limiting example, in an embodiment, user device 220 executes a routine to initiate interaction with personal journey authenticator module 200. For instance, in some embodiments, user device 220 executes a routine to instruct personal journey authenticator module 200 to monitor target system 210 according to embodiments described herein.

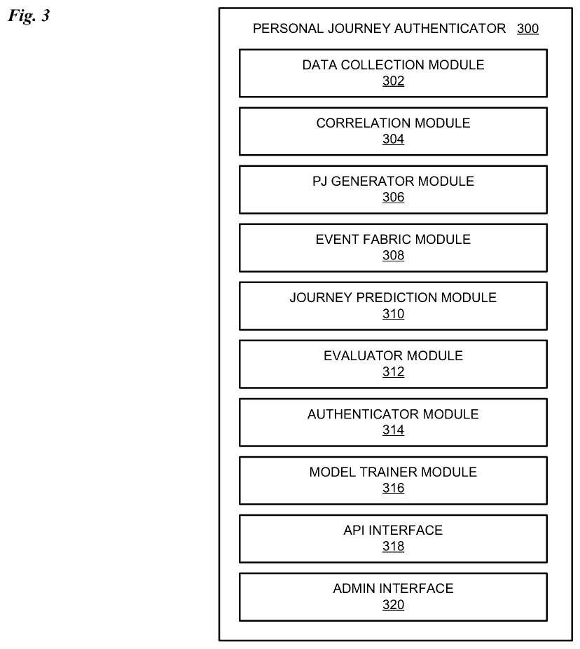

FIG. 3 depicts a block diagram of an example personal journey authentication module in accordance with an illustrative embodiment. In an embodiment, personal journey authentication module 300 includes personal journey authenticator module 200 of FIG. 1 and FIG. 2. In the illustrated embodiment, personal journey authentication module 300 includes a data collection module 302, a correlation module 304, a personal journey generator module 306, an event fabric module 308, a journey prediction module 310, an evaluator module 312, an authenticator module 314, a model trainer module 316, an API interface module 318, and an admin interface module 320. In alternative embodiments, personal journey authenticator module 300 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the data collection module 302 may be configured for gathering data from various sensors and sources, such as cameras, RFID sensors, WiFi signals, and biometric scanners, and other data sources, as described in greater detail herein. In an embodiment, the data collection module 302 collects real-time data on the user's movements, interactions, and environmental conditions during their personal journey. The data collection module interacts with the correlation module 304 by providing raw sensor data for further processing and analysis.

In the illustrated embodiment, the correlation module 304 is configured to processes the data collected by the data collection module 302 to identify patterns, correlations, and anomalies in the user's behavior and interactions with the environment. This module correlates different types of sensor data to create a coherent picture of the user's personal journey. The correlation module 304 interacts with the personal journey generator module 306 by providing analyzed data to generate personalized journey profiles.

In the illustrated embodiment, the personal journey generator module 306 utilizes the correlated data from the correlation module 304 to create personalized journey profiles for each user. These profiles capture the unique patterns and behaviors of the user as they navigate through the building or environment. In an embodiment, the personal journey generator module 306 interacts with the event fabric module 308 by feeding the generated journey profiles into the event fabric for real-time tracking and authentication.

In the illustrated embodiment, the event fabric module 308 serves as a central hub for real-time event collection and tracking within the building or environment. This module integrates data from the personal journey generator module 306, as well as other sources such as keycard readers, elevators, and cameras, to create a dynamic map of the user's movements. The event fabric module interacts with all other components to provide a comprehensive view of the user's personal journey and enable secure authentication based on real-time events and data. Accordingly, the data collection module 302 gathers sensor data, the correlation module 304 analyzes the data, the personal journey generator module 306 creates personalized journey profiles, and the event fabric module 308 integrates all data for real-time tracking and authentication. Each component may interacts with the other components to ensure a robust and accurate personal journey authentication process.

In the illustrated embodiment, the journey prediction module 310 utilizes historical data and one or more machine learning algorithms to predict the user's future movements and behaviors during their personal journey. By analyzing past patterns and behaviors, this module can anticipate the user's next steps and locations within the building. The journey prediction module interacts with the data collection module 302 and the personal journey generator module 306 to incorporate predictive insights into the user's journey profiles.

In the illustrated embodiment, the evaluator module 312 assesses the accuracy and reliability of the personal journey authentication process by comparing the predicted journey profiles with the actual user movements. This module evaluates the consistency and alignment between predicted and observed behaviors to ensure the authenticity of the user's personal journey. The evaluator module interacts with the journey prediction module 310 and the correlation module 304 to validate the accuracy of the predictions and correlations.

In the illustrated embodiment, the authenticator module 314 is responsible for verifying the user's identity and granting access based on the generated journey profiles and authentication criteria. This module uses the personalized journey data, biometric information, and/or access permissions to authenticate the user during their personal journey. The authenticator module interacts with the evaluator module 312 and the event fabric module 308 to make real-time authentication decisions based on the user's movements and interactions.

In the illustrated embodiment, the model trainer module 316 continuously refines and updates the machine learning models used in the authentication process. This module leverages feedback from the evaluator module 312 and the authenticator module 314 to improve the accuracy and performance of the predictive algorithms and authentication mechanisms. The model trainer module interacts with all other components to ensure that the authentication models are up-to-date and effective in verifying the user's personal journey. Accordingly, in some embodiments, the journey prediction module 310 predicts future user movements, the evaluator module 312 assesses accuracy, the authenticator module 314 verifies user identity, and the model trainer module 316 refines machine learning models. In some embodiments, each component interacts with the others to enhance the overall effectiveness and security of the personal journey authentication process.

In the illustrated embodiment, model trainer module 316 includes a model trainer component. In some embodiments, model trainer module 316 includes a data preparation module, algorithm module, training engine, and machine learning model. In alternative embodiments, model trainer module 316 can include some or all of the functionality described herein but grouped differently into one or more modules. In some embodiments, model trainer module 316 generates a machine learning model based on an algorithm provided by algorithm module. In an embodiment, algorithm module selects the algorithm based on one or more known machine learning algorithms. In an embodiment, model trainer 316 includes a training engine that trains a machine learning model using a training dataset. In some embodiments, training dataset includes historical event data for training a model to predict the next action, actions, sequence of actions, and/or personal journey of a user.

In some embodiments, the training dataset is pre-processed by a data preparation module for the model trainer. In some such embodiments, data preparation module structures the data to make best use of machine learning model. In an embodiment, the training engine trains machine learning model using training dataset, resulting in trained machine learning model. In some embodiments, training dataset is divided into two discrete subsets, where one subset is used by training engine for initially training machine learning model. The other subset is used by the training engine to test the trained model and determine the accuracy of the trained model.

In the illustrated embodiment, an API interface 318 allows personal journey authenticator module 300 to interact with and transmit data and executable commands between various applications. In some embodiments, the API interface 318 establishes a connection with various security related tools, and causes said security related tools to execute specific actions and processes, as described in greater detail herein.

In the illustrated embodiment, an administrative interface module 320 allows users with administrative privileges to perform various administrative tasks associated with personal journey authenticator module 300 as described herein. For example, in some embodiments, administrative interface 320 allows an administrative user to initiate a data collection process or system monitoring process. As another example, in some embodiments, administrative interface module 320 allows a user with administrative privileges to initiate and monitor the training process performed by model trainer module 316, including setting desired hyperparameters for the training process.

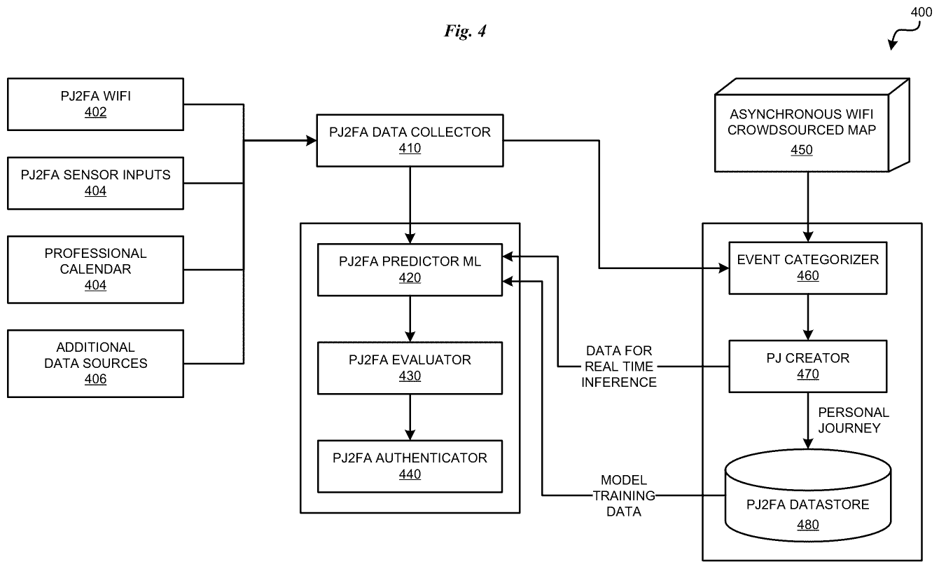

FIG. 4 depicts a block diagram of an example system for providing personal journey based authentication in accordance with an illustrative embodiment. In the illustrated embodiment, the personal journey authenticator module 200 of FIGS. 1 and 2 and/or security personal journey authenticator module 300 of FIG. 3 is configured to carry out operations depicted by system 400 FIG. 4.

In the illustrated embodiment, the personal journey data collector module 410 collects data from a variety of data sources. In some embodiments, the personal journey data collector module 410 collects data from the PJ2FA Wi-Fi module 402, the PJ2FA sensor inputs 404, the professional calendar module 406, and/or additional data sources 408. The data provided by each of these modules may include any data described herein in greater detail. In the illustrated embodiment, the PJ data collector module 410 transmits the collected data to an event categorizer module 460.

In the illustrated embodiment, the event categorizer module 460 receives the data collected by the data collector module and categorizes the data into different types of events based on predefined criteria. This categorization process enables identifying patterns and sequences within the user's personal journey. In the illustrated system, the personal journey creator 470 utilizes the output from the event categorizer module 460 to create a unique personal journey for the user. This personal journey includes a sequence of categorized events that the user has experienced within the physical space. Accordingly, the personal journey may serve as a distinctive identifier for the user during the authentication process.

In the illustrated system, the PJ2FA datastore 480 is responsible for storing the generated personal journeys for each user. This datastore allows for personal journeys to be securely stored and can be retrieved when needed for authentication purposes. In some embodiments, the system can compare the user's current journey with their stored journey to authenticate their identity based on the uniqueness of their personal journey.

In the illustrated embodiment, The PJ2FA Predictor Machine Learning Module 420 utilizes the personal journey data stored on the PJ2FA Datastore 480 to train a machine learning model to predict a sequence of events based on previously observed sequences of events from personal journeys belonging to a specific user. In an embodiment, the PJ2FA Machine Learning Module 420 leverages the stored personal journey data to create a training dataset for the machine learning model. This dataset consists of sequences of events experienced by users during their personal journeys. By analyzing these sequences, the machine learning model can learn the patterns and relationships between different events, enabling the model to predict the next event in a sequence based on historical data.

Further, during the training process, the machine learning model leverages algorithms and statistical techniques to identify correlations and dependencies between events within personal journeys. By learning from the historical data stored in the PJ2FA Datastore 480, the machine learning model can improve its accuracy in predicting future sequences of events for a specific user. Once the machine learning model is trained using the personal journey data, the model can be used in real-time scenarios to predict the sequence of events that a user is likely to experience based on their past interactions within the physical space. This predictive capability enhances the authentication process by verifying the user's identity based on the expected sequence of events in their personal journey.

In an embodiment, a personal journey includes the collection of events of a person as they move through a monitored space. This journey begins when the person enters the space for the first time or when they depart from their device that will later require authentication. Events within a personal journey can encompass physical movements tracked through the triangulation of the person's smart devices via WiFi access points or access events recorded by various building sensors such as WiFi sensors, card readers, elevators, cameras, and more, as describe in greater detail herein.

The data collected from these sensors are associated with the individual person and their unique patterns of movement within the environment. In some embodiments, this correlation is established based on the person's WiFi location data and can be optionally supplemented with data from the gyroscope and accelerometer sensors present in their smart devices, such as smartphones or smartwatches. By combining these different sources of data, a comprehensive picture of the person's journey through the space is constructed, allowing for detailed tracking and analysis of their movements and interactions.

Further, a person's journey concludes either when they exit the monitored space or when they engage in an authentication process where the journey can serve as a form of two-factor authentication (2FA). By utilizing the collected data and identifiable patterns of movement, the personal journey can be leveraged as a unique and secure method of authentication. This approach enhances security by verifying the person's identity based on their specific journey through the space, adding an additional layer of protection to the authentication process.

In the illustrated embodiment, the PJ creator module 470 provides data for real-time inference to the PJ2FA Predictor Module 420. Accordingly, the PJ Creator 470 may be configured for continuously generating and updating personal journeys based on the user's interactions within the monitored space. As the user moves through the environment, the PJ Creator 470 continuously collects data from various sensors and devices to create a real-time representation of the user's journey. The data collected by the PJ Creator 470 includes information about the user's current location, movements, and interactions within the space. This data is processed and used to update the user's personal journey in real-time, reflecting their most recent activities and events. By maintaining an up-to-date personal journey for each user, the PJ Creator 470 ensures that the authentication process remains accurate and secure.

The PJ Creator 470 feeds this real-time personal journey data to the PJ2FA Predictor Module 420 for inference. The PJ2FA Predictor Module 420 utilizes the latest personal journey information to predict the sequence of events that the user is likely to experience next based on their historical patterns and behaviors. By receiving continuous updates from the PJ Creator 470, the PJ2FA Predictor Module 420 can adapt its predictions in real-time to account for any changes in the user's movements or interactions within the space.

In an embodiment, the PJ2FA Predictor Module 420, the PJ2FA Evaluator Module 430, and the PJ2FA Authenticator Module 440 work together in a coordinated manner to enable the Personal Journey 2-Factor Authentication (PJ2FA) system to authenticate users based on their unique personal journeys. In the illustrated embodiment, the PJ2FA Predictor Module 420 is configured for predicting the sequence of events that a user

is likely to experience next based on their historical patterns and behaviors within the monitored space. By leveraging machine learning algorithms and the user's personal journey data, the Predictor Module 420 can anticipate the user's movements and interactions in real-time.

In the illustrated embodiment, the output of the PJ2FA Predictor Module 420 is then passed on to the PJ2FA Evaluator Module 430. The Evaluator Module 430 assesses the predicted sequence of events against the actual events observed in the user's personal journey and compares the predicted events with the user's real-time interactions to determine the level of similarity of the predictions made by the Predictor Module 420. Further, the PJ2FA Authenticator Module 440 utilizes the information provided by the Evaluator Module 430 to make a decision regarding the user's authentication. The Authenticator Module 440 evaluates the consistency between the predicted events, the actual events, and the user's stored personal journey data to determine if the user's identity can be verified based on their current interactions within the space. In some embodiments, authenticator module initiates a request for an additional factor of security upon determination by the evaluator module that the actual personal journey does not meet a threshold similarity level.

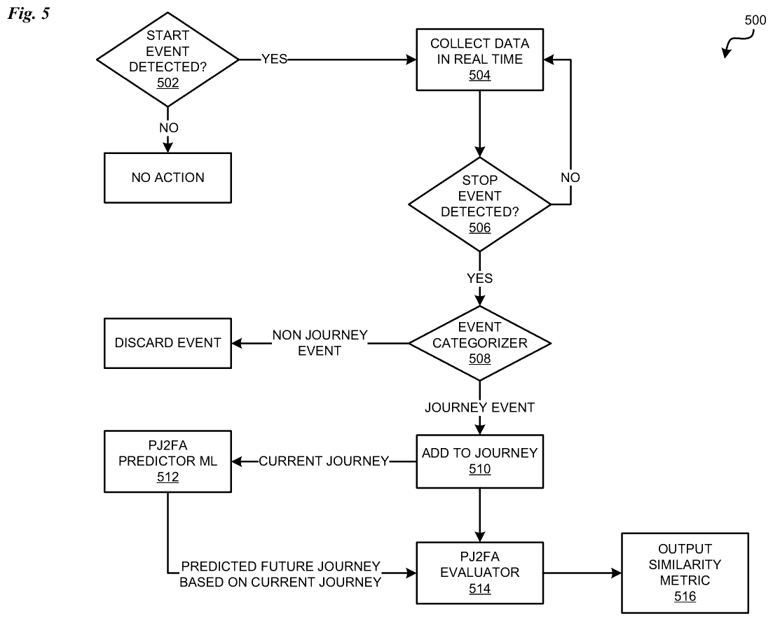

FIG. 5 depicts a flowchart of an example process for personal journey prediction and evaluation in accordance with an illustrative embodiment. In an embodiment, personal journey authenticator module 200 of FIGS. 1 and 2 and/or personal journey authenticator module 300 of FIG. 3 carries out aspects of process 500.

In an embodiment, at step 502, the process includes determining whether a start event is detected. If no start event is detected, the system takes no action and remains idle, awaiting further input. If a start event is detected, the process advances to the next step.

In an embodiment, at step 504, the process includes collecting data in real time. The system begins monitoring and recording relevant information continuously until further conditions are met. In an embodiment, at step 506, the process includes determining whether a stop event is detected. If no stop event is identified, the process continues collecting data in real time, maintaining its monitoring loop. Once a stop event is detected, the process moves forward for event categorization.

In an embodiment, at step 508, the process includes categorizing the event to determine whether the event qualifies as a journey-related event. If the event is identified as a non-journey event, the system discards the event, terminating its analysis for that particular input. Conversely, if the event is classified as a journey event, the system advances to integrate the data into the current journey.

In an embodiment, at step 510, the process includes adding the journey event to the existing dataset for the current journey. This integration ensures that all relevant data is captured for subsequent modeling and analysis, forming a comprehensive record of the journey.

In an embodiment, at step 512, the process includes utilizing the journey data in

a predictive machine learning model, i.e., the PJ2FA Predictor ML module. This model analyzes the current journey data and predicts potential future journey patterns or outcomes, leveraging historical and real-time insights.

In an embodiment, at step 514, the process includes evaluating the predicted future journey using the PJ2FA Evaluator. This step involves assessing the accuracy or alignment of the prediction against the actual personal journey currently being monitored. In an embodiment, at step 516, the process includes generating an output similarity metric. This metric quantifies the degree of alignment between the predicted journey and the actual journey, as assessed by the PJ2FA Evaluator.

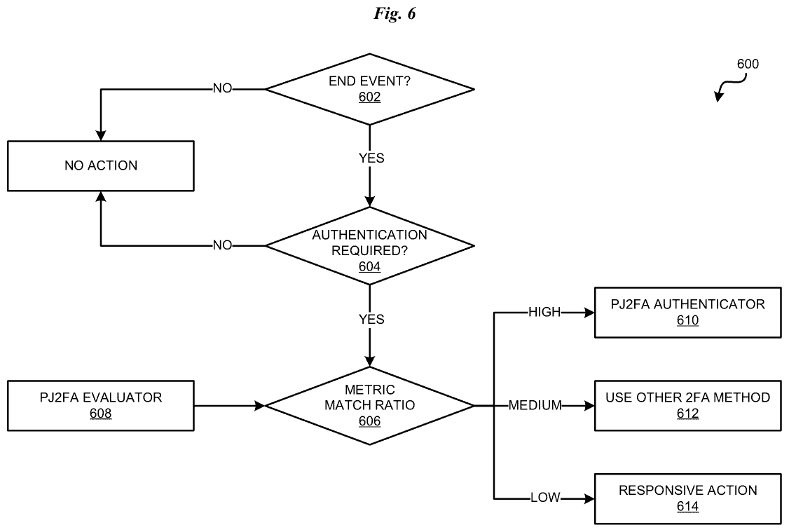

FIG. 6 depicts a flowchart of an example process for personal journey based authentication evaluation in accordance with an illustrative embodiment. In some embodiments, the personal journey authenticator module 200 of FIGS. 1 and 2, the personal journey authenticator module 300 of FIG. 3, and/or system 400 of FIG. 4 is configured to carry out some or all of process 600 depicted by FIG. 6.

In an embodiment, at step 602, the process includes determining whether an “end event” has been detected. If no end event is identified, the system takes no action and remains idle, awaiting further input. If an end event is detected, the process advances to the next step for further evaluation.

In an embodiment, at step 604, the process includes determining whether authentication is required for the detected event. If authentication is not necessary, the process terminates without further action. However, if authentication is required, the process moves forward to assess the event using one or more evaluation methods as described herein.

In an embodiment, at step 608, the process includes analyzing the personal journey event data using a PJ2FA Evaluator. This evaluator calculates a metric match ratio. In an embodiment, at step 606, the process includes categorizing the metric match ratio into one of three levels: high, medium, or low.

If the match ratio is high, the process proceeds to step 610, where the PJ2FA Authenticator is utilized to authenticate the identity of the user corresponding to a personal journey directly. If the match ratio is medium, the process moves to step 612, where an alternate or additional two-factor authentication (2FA) method is employed to validate the event. If the match ratio is low, the process proceeds to step 614, where a responsive action is triggered. The responsive action may include, but is not limited to, transmitting a notification or alert to a relevant stakeholder, denying access to a user, and/or initiating one or more additional verification protocols.

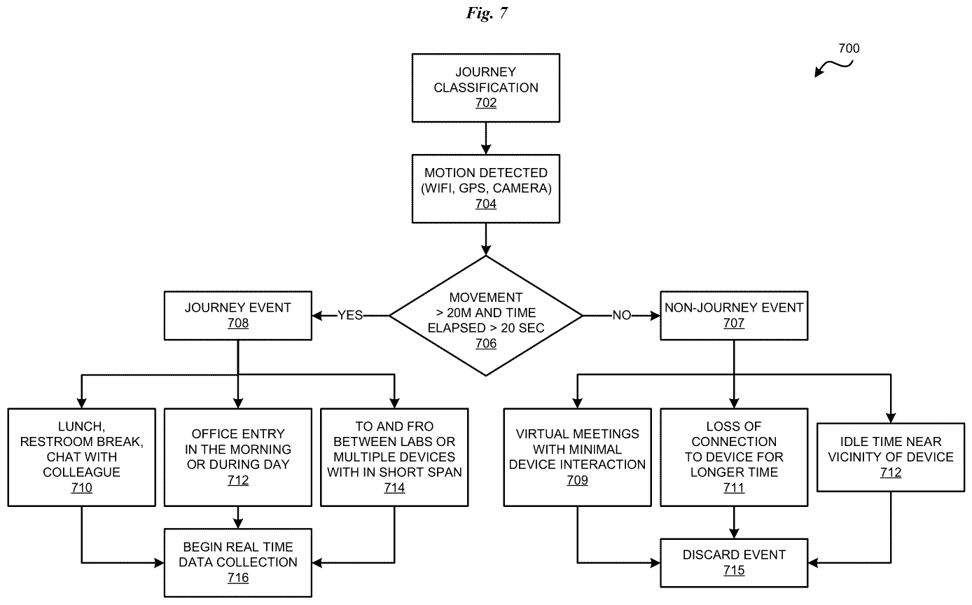

FIG. 7 depicts a flowchart of an example process for personal journey event categorization in accordance with an illustrative embodiment.

In an embodiment, at step 702, the process includes classifying an event to determine whether it is potentially part of a personal journey. This classification serves as the starting point for evaluating whether further analysis is required. In an embodiment, at step 704, the process includes detecting motion using tools such as Wi-Fi, GPS, or camera

systems. The detection of motion indicates potential movement, which is then analyzed to determine its relevance to a journey.

In an embodiment, at step 706, the process includes analyzing the detected motion to assess whether the movement exceeds 20 meters and if the elapsed time is greater than 20 seconds. If both conditions are met, the event is categorized as a “Journey Event” at step 708. If not, the event is classified as a “Non-Journey Event” at step 707. In an embodiment, at step 707, the process includes identifying non-journey events. These may include virtual meetings with minimal device interaction (step 709), a loss of connection to the device for an extended period (step 711), or idle time near the device (step 713). Such events are not relevant for journey tracking and are discarded at step 715.

In an embodiment, at step 708, the process includes identifying journey events. Examples of journey events may include, but are not limited to, lunch breaks, facilities breaks, or casual chats with colleagues (step 710), entering an office in the morning or during the day (step 712), and moving between labs or interacting with multiple devices in a short time span (step 714). For these events, real-time data collection is initiated at step 716 to capture relevant information for further analysis. This systematic approach ensures the accurate classification and handling of journey-related and non-journey-related events, focusing on relevant data while discarding unnecessary information.

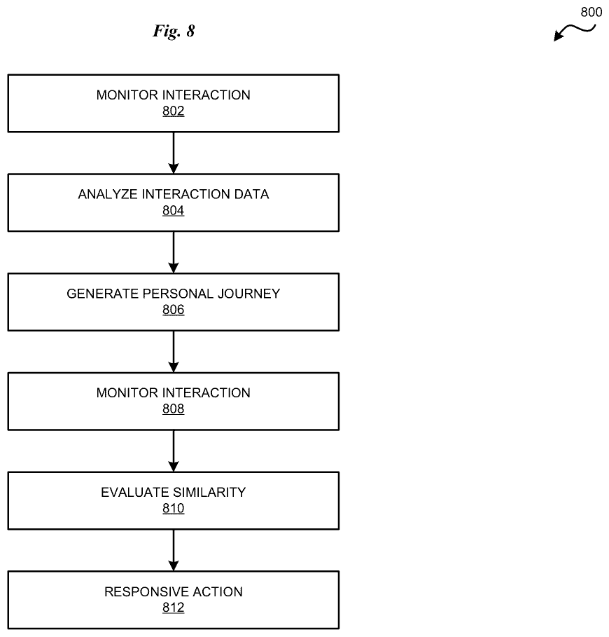

FIG. 8 depicts a flowchart of an example process for personal journey based secured authentication in accordance with an illustrative embodiment. In some embodiments, the personal journey authenticator module 200 of FIGS. 1 and 2, the personal journey authenticator module 300 of FIG. 3, and/or system 400 of FIG. 4 are configured to carry out some or all of process 800 depicted by FIG. 8.

In an embodiment, at step 802, the process monitors interactions of a user within a physical space over a period of time collect to interaction data corresponding to the user interactions. In an embodiment, at step 804, the process analyzes the interaction data to extract one or more events from the interaction data. In some embodiments, analyzing the interaction data may include categorizing extracted events into one of either personal journey events or non-personal journey events. In some such embodiments, non-personal journey events are discarded.

In an embodiment, at step 806, the process generates a personal journey based on the events extracted from the event data. In an embodiment, at step 808, the process monitors interaction of a user within a physical space over a period of time to collect interaction data during a second interaction session. In an embodiment, at step 810, the process compares similarity of one or more personal journeys corresponding to the user to one a present personal

journey of a user based on present collected interaction data. In an embodiment, the process includes predicting a subsequent action, and comparing the actual subsequent action to the predicted subsequent action to evaluate similarity between the predicted personal journey and the actual person journey.

In an embodiment, at step 812, the process initiates a responsive action upon determining the results of the evaluation. Examples of responsive actions may include, but are not limited to, granting access to a secure access point, denying access to a secure access point, requesting additional authentication from the user, and/or initiating a security breach response action. Accordingly, upon determining the outcome of the evaluation, the system may trigger various responsive actions to manage the authentication process effectively. process may grant access to a secure access point if the user's personal journey aligns with the expected pattern, allowing the user to proceed with the authentication process seamlessly. Conversely, if the evaluation indicates discrepancies or anomalies in the user's personal journey, the system may deny access to a secure access point to prevent unauthorized entry and enhance security measures.

Furthermore, in situations where the evaluation results are inconclusive or require additional verification, the process may prompt the user to provide supplementary authentication credentials or undergo further verification steps to validate their identity. This additional authentication step adds an extra layer of security to the authentication process, ensuring that only authorized users can access the secure environment. In the event of a potential security breach or suspicious activity detected during the evaluation, the process may initiate a security breach response action to mitigate the risk and safeguard the system's integrity. This response action could involve triggering alerts to security personnel, logging the incident for further investigation, or implementing predefined security protocols to contain and address the potential threat effectively. By incorporating a range of responsive actions based on the evaluation results, the process can adapt dynamically to different authentication scenarios, enhancing security measures, and ensuring a robust authentication process for users interacting within the monitored physical space.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating

expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
initiating a first data collection process to collect event data corresponding to a user interacting within a space;
extracting one or more events from the event data collected;
generating a personal journey based on the one or more events extracted from the event data collected, wherein the personal journey comprises a first sequence of events;
initiating, upon detection of a first trigger condition, a second data collection process to collect additional event data corresponding to the user interacting within the space;
generating a predicted sequence of events based on a portion of the additional event data and the first sequence of events;
generating an actual sequence of events based on the additional event data;
generating, by computationally comparing the actual sequence of events to the predicted sequence of events, a similarity metric between the actual sequence of events and the predicted sequence of events; and
initiating a first responsive action upon determination that the similarity metric does not meet a predefined similarity metric threshold.

2. The computer-implemented method of claim 1, wherein the first responsive action includes initiating a request for additional authentication information.

3. The computer-implemented method of claim 1, wherein the first responsive action includes denying access to a secure access point.

4. The computer-implemented method of claim 1, wherein the first trigger condition comprises moving a predefined distance away from a secure access point.

5. The computer-implemented method of claim 1, wherein the first data collection process comprises collecting body movement data corresponding to the user.

6. The computer-implemented method of claim 1, wherein the first data collection process comprises collecting movement speed data corresponding to the user.

7. A computer program product comprising one or more computer readable storage media, and program instructions collectively stored on the one or more computer readable storage media, the program instructions executable by a processor to cause the processor to perform operations comprising:
initiating a first data collection process to collect event data corresponding to a user interacting within a space;
extracting one or more events from the event data collected;
generating a personal journey based on the one or more events extracted from the event data collected, wherein the personal journey comprises a first sequence of events;
initiating, upon detection of a first trigger condition, a second data collection process to collect additional event data corresponding to the user interacting within the space;
generating a predicted sequence of events based on a portion of the additional event data and the first sequence of events;
generating an actual sequence of events based on the additional event data;
generating, by computationally comparing the actual sequence of events to the predicted sequence of events, a similarity metric between the actual sequence of events and the predicted sequence of events; and
initiating a first responsive action upon determination that the similarity metric does not meet a predefined similarity metric threshold.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, wherein the first responsive action includes initiating a request for additional authentication information.

11. The computer program product of claim 7, wherein the first responsive action includes denying access to a secure access point.

12. The computer program product of claim 7, wherein the first trigger condition comprises moving a predefined distance away from a secure access point.

13. The computer program product of claim 7, wherein the first data collection process comprises collecting body movement data corresponding to the user.

14. The computer program product of claim 7, wherein the first data collection process comprises collecting movement speed data related data corresponding to the user.

15. A computer system comprising a processor and one or more computer readable storage media, and program instructions collectively stored on the one or more computer readable storage media, the program instructions executable by the processor to cause the processor to perform operations comprising:
initiating a first data collection process to collect event data corresponding to a user interacting within a space;
extracting one or more events from the event data collected;
generating a personal journey based on the one or more events extracted from the event data collected, wherein the personal journey comprises a first sequence of events;
initiating, upon detection of a first trigger condition, a second data collection process to collect additional event data corresponding to the user interacting within the space;
generating a predicted sequence of events based on a portion of the additional event data and the first sequence of events;
generating an actual sequence of events based on the additional event data;
generating, by computationally comparing the actual sequence of events to the predicted sequence of events, a similarity metric between the actual sequence of events and the predicted sequence of events; and
initiating a first responsive action upon determination that the similarity metric does not meet a predefined similarity metric threshold.

16. The computer system of claim 15, wherein the first responsive action includes initiating a request for additional authentication information.

17. The computer system of claim 15, wherein the first responsive action includes denying access to a secure access point.

18. The computer system of claim 15, wherein the first trigger condition comprises moving a predefined distance away from a secure access point.

19. The computer system of claim 15, wherein the first data collection process comprises collecting body movement data corresponding to the user.

20. The computer system of claim 15, wherein the first data collection process comprises collecting movement speed data corresponding to the user.
